(19) United States
(12) Patent Application Publication
(10) Pub. No.: US 2006/0128210 A1
(43) Pub. Date: Jun. 15, 2006

(54) Weatherproof cover to protect outdoor electrical plug connections.

(76) Inventor: Mike Peters, Miramar, FL (US)

Correspondence Address: Mike Peters, 13132 SW 23 Street, Miramar, FL, 33027, US

(21) Appl. No.: 10/905,035

(22) Filed: Dec. 12, 2004

(51) Int. Cl. H01R 13/52

(52) U.S. Cl. 439/521

(57) ABSTRACT

This invention is a weatherproof cover to protect outdoor electrical plug connections. The cover is a plastic box that is open on the bottom. There are spiked legs at each corner which can be pushed into the ground to hold the cover securely in place. A hook and loop fabric fastener allows the plugs to be strapped to the underside of the cover, protected from the weather and away from the ground which may become wet.

### BACKGROUND OF THE INVENTION

Electrical cords are often used outdoors where they are exposed to weather conditions such as rain, snow, and ice. This is especially true during the holiday season when it is common practice to place electric lights and decorations around the house and yard. These lights are usually connected with extension cords which lay in the grass.

At the point where electrical cords are plugged together, water can easily make contact. This creates an unsafe condition when the ground becomes wet due to various weather conditions and even when the sprinklers are turned on.

When electrical cords are used outdoors, they are usually plugged into outlets which use a GFI (Ground Fault Interrupter) breaker that will shut down if the connection gets wet. GFI utilizes a very small set of current transformers to determine if there is a difference between the current in one wire verses the return current in the other wire within an electrical circuit. If there is a difference, the GFI will trip in order to prevent electrocution.

Because water is conductive, outdoor lights tend to trip GFI circuits in bad weather conditions. When an electrical cord connection comes in contact with water, a conductive path is made throughout the whole plug or receptacle. If the connections are kept dry, the chances of tripping the breaker are kept to a minimum.

There are existing patents which provide protective covers for outdoor outlets. For example, U.S. Pat. No. 6,420,654 describes an electrical outlet cover. However, these covers provide protection at the outlet while the plugs that lay in the grass remain exposed.

There are also patents which provide a protected electrical outlet assembly. For example, U.S. Pat. No. 5,879,184 describes an assembly which includes outlets integrated with a protective cover. However, the connections away from the outlets still remain exposed.

Other patents, such as U.S. Pat. No. 6,099,340, describe a waterproof container for electrical plugs and sockets, however these containers are enclosed on all sides, which makes it difficult to provide a watertight seal at the point where the cord enters the enclosure. In this case, the gaskets will not adequately seal multiple cords of various sizes.

It is preferable to have a much more flexible method for keeping outdoor electrical plug connections dry. By providing a simple and easy-to-fabricate cover which allows plugs to be covered and lifted off the ground, multiple connections of various sizes can be protected.

### BRIEF SUMMARY OF THE INVENTION

This invention is a weatherproof cover to protect outdoor electrical plug connections. The cover is a plastic box that is open on the bottom. There are spiked legs at each corner which can be pushed into the ground to hold the cover securely in place. A Velcro strap allows the plugs to be strapped to the underside of the cover, protected from the weather and away from the ground which may become wet.

There are many advantages of such a device:

(1) By keeping electrical plug connections dry, the risk of tripping the breakers due to weather conditions is minimized.

(2) The risk of tripping the breakers due to a sprinkler system is also minimized.

(3) By minimizing the risk of tripping the breakers, it is less likely that the power in the house will be interrupted.

### BRIEF DESCRIPTION OF THE SEVERAL VIEWS OF THE DRAWINGS

In order that the invention may be more fully understood, it will now be described, by way of example, with reference to the accompanying drawings in which:

FIG. 1 is a perspective view of the cover.

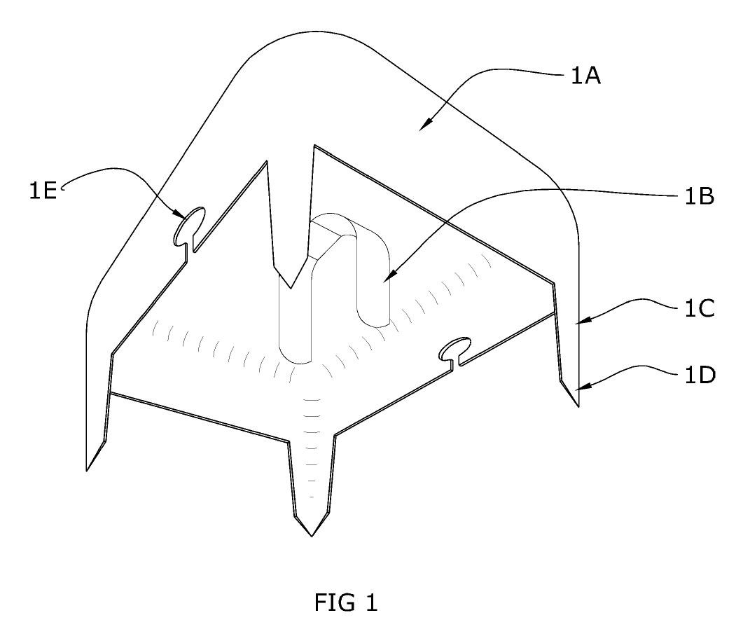

FIG. 2 is a section through the center of the cover.

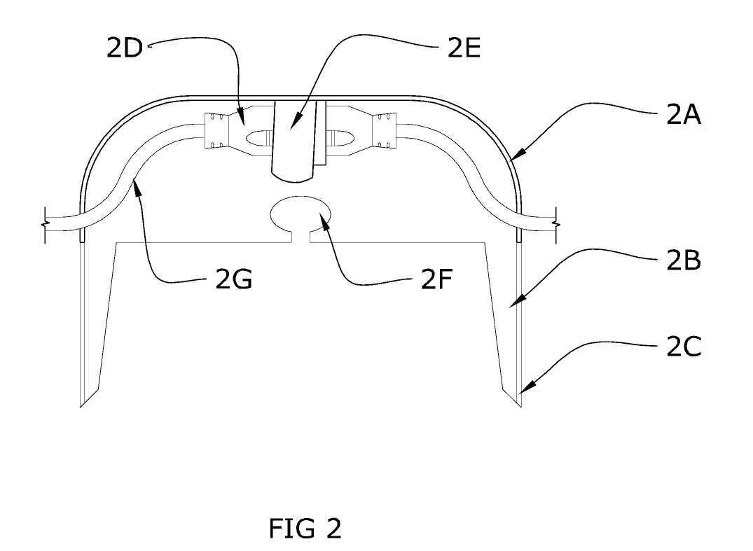

FIG. 3 is a plan of the underside of the cover.

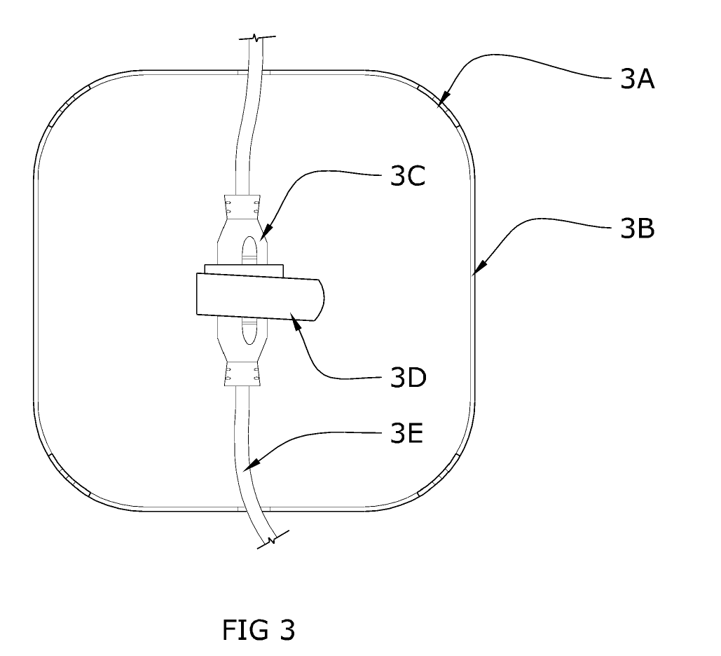

### DETAILED DESCRIPTION OF THE INVENTION

This invention is a weatherproof cover to protect outdoor electrical plug connections. The cover is a plastic box that is open on the bottom. There are spiked legs at each corner which can be pushed into the ground to hold the cover securely in place. A Velcro strap allows the plugs to be strapped to the underside of the cover, protected from the weather and away from the ground which may become wet.

The cover can protect terminals and cords of various sizes by providing a water-impervious shield encompassing the coupled plugs of electrical cords. By keeping the connections between electrical cords dry, it prevents the GFI breakers from tripping and reduces the risk of shock.

The invention is composed of the following components, as illustrated in the accompanying diagrams:

A weatherproof plastic box (1A, 2A, 3B) that is open on the bottom and is large enough to completely cover and protect plugs (2D, 3C) from a single or multiple electrical cord connections. The invention may be constructed using various box sizes in order to accommodate different numbers of plug connections.

A Velcro strap (1B, 2E, 3D) is attached to the underside of the box. The strap allows the plugs (2D, 3C) to be strapped to the underside of the box away from the ground which may become wet from rain, snow, or ice.

Plastic legs (1C) extend downward from each corner of the box. Each leg is angled with a sharp point (1D) which allows the legs to be easily pushed into the ground.

Notches (1E) in the plastic cover to hold the cords (2G, 3E) in place. The notches can be various sizes and shapes to accommodate a wide range of electrical cords.

What is claimed is:

1. A weatherproof cover to protect outdoor electrical plug connections; comprising of a plastic cover with spiked legs at each corner and a Velcro strap attached to the underside of the cover.

2. A weatherproof cover as defined in claim 1 wherein the cover is open on the bottom.

3. A weatherproof cover as defined in claim 1 wherein there are spiked legs at each corner which can be pushed into the ground to hold the cover securely in place.

4. A weatherproof cover as defined in claim 1 wherein a Velcro strap allows electrical plugs to be strapped to the underside of the cover, protected from the weather and away from the ground which may become wet.

5. A weatherproof cover as defined in claim 1 wherein there are notches on each side to hold the cords in place.
